(19) United States
(12) Patent Application Publication
(10) Pub. No.: US 2002/0050854 A1
(43) Pub. Date: May 2, 2002

(54) Bandgap reference circuit with a pre-regulator

(76) Inventors: Gang Zha, Shenzhen (CN); Solomon K. Ng, Shenzhen (CN)

Correspondence Address: Stuart T. Langley, Esq., Hogan & Hartson, LLP, Suite 1500, 1200 17th Street, Denver, CO, 80202, US

(21) Appl. No.: 09/989,221

(22) Filed: Nov. 20, 2001

Related U.S. Application Data
(63) Continuation of application No. 09/643,171, filed on Aug. 21, 2000.

(30) Foreign Application Priority Data
Sep. 2, 1999 (CN) 99118480.7

(51) Int. Cl. G05F 1/10

(52) U.S. Cl. 327/539

(57) ABSTRACT

A bandgap reference circuit has a pre-regulator that achieves a low temperature coefficient through the use of a first component that generates a first voltage having a negative temperature coefficient and a second component coupled in series to the first component and which generates a second voltage having a positive temperature coefficient. This low temperature coefficient in the pre-regulator allows the bandgap reference circuit to output the bandgap voltage VBG with a low temperature coefficient.

### CROSS REFERENCE TO RELATED APPLICATIONS

This application is a continuation of U.S. patent application Ser. No. 09/643,171, filed Aug. 21, 2000 and entitled “Improved Bandgap Reference Circuit,” which is specifically incorporated herein by reference.

### TECHNICAL FIELD OF THE INVENTION

This invention relates in general to bandgap reference circuits and, more specifically, to devices and methods for providing bandgap reference circuits with low temperature coefficients.

### BACKGROUND OF THE INVENTION

As shown in FIG. 1, a conventional bandgap reference circuit 10 includes a pre-regulator 12 that generates a regulated voltage V_{REG} off the supply voltage V_{CC} using a pair of current-mirror transistors Q1 and Q2, a resistor R1, and a set of series-connected diodes D1, D2, and D3. In addition, a start-up circuit 14—consisting of a bias transistor Q3, another set of series-connected diodes D4 and D5, and a resistor R2- biases a pair of V_{BE}-differential transistors Q4 and Q5 at start-up, after which the transistor Q3 shuts off, thereby effectively isolating the start-up circuit 14 from the rest of the bandgap reference circuit 10.

Together, a current source transistor Q9 and a V_{BE}-differential circuit 16 generate a differential voltage V_{DIF} having a positive temperature coefficient from the regulated voltage V_{REG} using a pair of current-mirror transistors Q6 and Q7, the V_{BE}-differential transistors Q4 and Q5, a pair of resistors R3 and R4, and a driver transistor Q8. As a result, the bandgap voltage V_{BG} output from the bandgap reference circuit 10 across a resistor R5 equals the differential voltage V_{DIF} plus the base-emitter voltage V_{BE} of the transistor Q5. Because the base-emitter voltage V_{BE} has a negative temperature coefficient, any variations in the base-emitter voltage V_{BE} due to temperature are countered by variations in the differential voltage V_{DIF}, so that the bandgap voltage V_{BG} should be relatively temperature independent. Unfortunately, the negative temperature dependence of the diodes D1, D2, and D3 makes the regulated voltage V_{REG} relatively temperature dependent, which, in turn, makes the bandgap voltage V_{BG} relatively temperature dependent.

Accordingly, there is a need in the art for an improved bandgap reference circuit that has a low temperature coefficient.

### SUMMARY OF THE INVENTION

In accordance with this invention, a pre-regulator for generating a regulated voltage for use in generating a bandgap voltage from a bandgap reference circuit includes a current source (e.g., a wilson current source) and a V_{BE} multiplier that receives current therefrom and generates/clamps the regulated voltage. Also, feedback circuitry regulates the current flow from the current source in response to feedback from the bandgap voltage.

In other embodiments of this invention, the pre-regulator described above is incorporated into a bandgap reference circuit.

In still another embodiment of this invention, a reference voltage is generated by driving a current into a V_{BE} multiplier to generate and clamp a regulated voltage. The current is regulated in response to feedback from the reference voltage. Also, a V_{BE} differential voltage is generated from the regulated voltage using a V_{BE} differential circuit, and the reference voltage is generated from the V_{BE} differential voltage and a base-emitter voltage drop.

### BRIEF DESCRIPTION OF THE FIGURES

FIG. 1 is a circuit schematic illustrating a conventional bandgap reference circuit; and

FIG. 2 is a circuit schematic illustrating a bandgap reference circuit in accordance with this invention.

### DETAILED DESCRIPTION OF THE ILLUSTRATED EMBODIMENTS

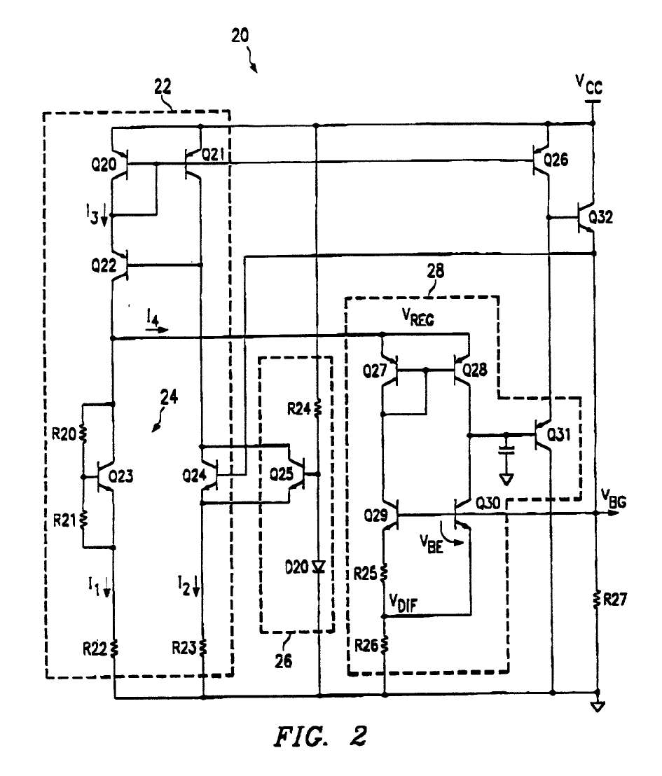

As shown in FIG. 2, a bandgap reference circuit 20 in accordance with this invention includes a pre-regulator 22 that generates a regulated voltage V_{REG} off the supply voltage V_{CC} using a set of Wilson current source transistors Q20, Q21, and Q22, a V_{BE}-multiplier 24 (consisting of a pair of resistors R20 and R21 and a transistor Q23), a feedback transistor Q24, and a pair of bias resistors R22 and R23. In addition, a start-up circuit 26—consisting of a bias transistor Q25, a diode D20, and a resistor R24—draws current from the Wilson current source transistors Q20, Q21, and Q22 at start-up. Once the bandgap voltage V_{BG} is established, the transistor Q25 shuts off.

Together, a current source transistor Q26 and a V_{BE}-differential circuit 28 generate a differential voltage V_{DIF} having a positive temperature coefficient from the regulated voltage V_{REG} using a pair of current-mirror transistors Q27 and Q28, a pair of V_{BE}-differential transistors Q29 and Q30, a pair of resistors R25 and R26, and a driver transistor Q31. As a result, the bandgap voltage V_{BG} output from the bandgap reference circuit 20 across a resistor R27 equals the differential voltage V_{DIF} plus the base-emitter voltage V_{BE} of the transistor Q30. Because the base-emitter voltage V_{BE} has a negative temperature coefficient, any variations in the base-emifter voltage V_{BE} due to temperature are countered by variations in the differential voltage V_{DIF}, so that the bandgap voltage V_{BG} is relatively temperature independent. An output transistor Q32 provides current to the bandgap voltage V_{BG}.

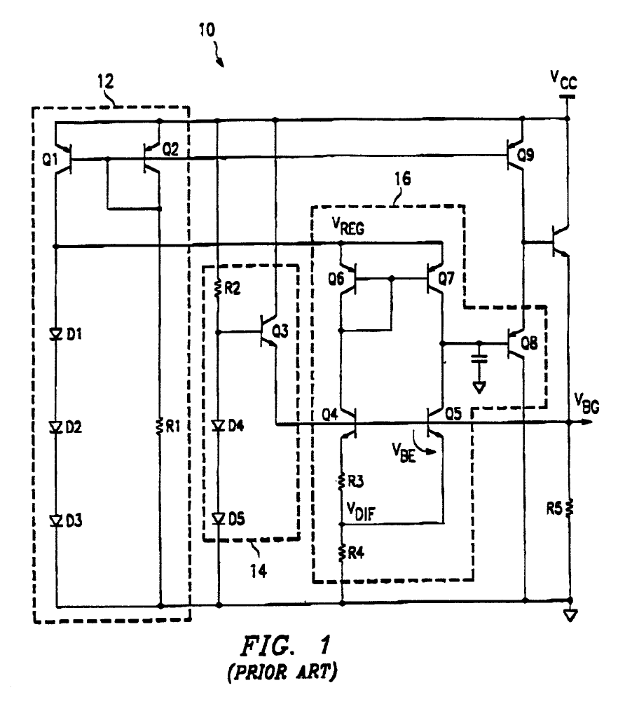

The improved pre-regulator 22 gives the bandgap reference circuit 20 a lower temperature coefficient than the conventional bandgap reference circuit 10 (see FIG. 1) previously described by providing a regulated voltage V_{REG} with a lower temperature coefficient. Specifically, the temperature coefficient T_{C} of the regulated voltage V_{REG} can be calculated as follows.

The currents I₁, I₂, I₃, and I₄ can be determined as follows:

I₂=(V_{BG}−V_{BE})/R23 (1)

I₃=N(V_{BG}−V_{BE})/R23 (2)

where N is the size of the transistor Q20 relative to the transistor Q21,

$$\begin{matrix}{I}_{4} = 2 ( {V}_{BEQ30} - {V}_{BEQ29 )} / R25 & ( 3 ) \\ = 2 {V}_{T} ln ( A ) / R25 & ( 4 )\end{matrix}$$

where A is the size of the transistor Q29 relative to the transistor Q30,

$$\begin{matrix}{I}_{1} = {I}_{3} - {I}_{4} & ( 5 ) \\ = ( N ( {V}_{BG} - {V}_{BE} ) / R23 ) - ( 2 {V}_{T} ln ( A ) / R25 ) & ( 6 )\end{matrix}$$

In addition, the regulated voltage V_{REG} can be calculated as follows:

$$\begin{matrix}{V}_{REG} = ( 1 + m ) {V}_{BE} + {I}_{1} R22 & ( 7 ) \\ = ( 1 + m ) {V}_{BE} + ( N ( R22 / R23 ) ) ( {V}_{BG} - {V}_{BE} ) - 2 {V}_{T} ln ( A ) ( R22 / R25 ) & ( 8 ) \\ = {NV}_{BG} ( R22 / R23 ) + ( 1 + m - N ( R22 / R23 ) ) {V}_{BE} - 2 {V}_{T} ln ( A ) ( R22 / R25 ) & ( 9 )\end{matrix}$$

where m is the value of the resistor R20 relative to the resistor R21.

Further, the temperature coefficient T_{C} can be calculated as follows:

$$\begin{matrix}{T}_{c} = ⅆ {V}_{REG} / ⅆ T & ( 10 ) \\ = ( 1 + m - N ( R22 / R23 ) ) ( ⅆ {V}_{BE} / ⅆ T ) - 2 ln ( A ) ( R22 / R25 ) ( ( ⅆ {V}_{T} / ⅆ T ) & ( 11 )\end{matrix}$$

Setting T_{C}=0, and assuming dV_{BE}/dT=−2 mV/° C. and dV_{T}/dT=0.086 mV/° C., we find the following:

(1+m−N(R22/R23))/(2ln(A)(R22/R25))=(dV_{T}/dT)/(dV_{BE}/dT)=−0.086/2 (12)

We can then calculate appropriate values for m, N, R22, R23, A, and R25 from equations (9) and (12) above so as to achieve the desired regulated voltage V_{REG} and a zero (or close to zero) temperature coefficient T_{C}. For example, a regulated voltage V_{REG} of 1.66V and a temperature coefficient T_{C} of 0.09 mV/° C. can be achieved with N=2, A=6, m=0.4, R22, R23=8 KOhms, and R25=2.4 KOhms.

This invention thus provides a low temperature coefficient bandgap reference circuit. Also, the use of a Wilson current source in the pre-regulator helps the reference circuit achieve a Power Supply Rejection Ratio (PSRR) exceeding 80 dB. Further, the circuit is able to operate using low supply voltages (e.g., V_{CC}=2.7 Volts).

Of course, it should be understood that although this invention has been described with reference to bipolar transistors, it is equally applicable to other transistor technologies, including MOSFET technologies.

Although this invention has been described with reference to particular embodiments, the invention is not limited to these described embodiments. Rather, the invention is limited only by the appended claims, which include within their scope all equivalent devices and methods that operate according to the principles of the invention as described.

1. A temperature compensated pre-regulator for generating a regulated voltage having a low temperature coefficient for use in generating a reference voltage, the pre-regulator comprising:
a current source;
a first component coupled to the current source and which generates a first voltage having a negative temperature coefficient; and
a second component coupled in series to said first component and to said current source and which generates a second voltage having a positive temperature coefficient, wherein said regulated voltage comprises a combination of said first and second voltages.

2. The pre-regulator of claim 1, wherein said first component comprises a V_{BE} multiplier.

3. The pre-regulator of claim 1, wherein said second component comprises a proportional-to-absolute-temperature (PTAP) circuit.

4. The pre-regulator of claim 1, wherein said current source comprises a Wilson current source.

5. The pre-regulator of claim 1, further comprising feedback circuitry coupled to the current source for regulating the current flow therefrom directly in response to feedback from the reference voltage.

6. A circuit for generating a reference voltage, the circuit comprising:
(a) a temperature compensated pre-regulator for generating a regulated voltage having a low temperature coefficient, the pre-regulator including:
a current source;
a first component coupled to the current source and which generates a first voltage having a negative temperature coefficient; and
a second component coupled in series to said first component and to said current source and which generates a second voltage having a positive temperature coefficient, wherein said regulated voltage comprises a combination of said first and second voltages;
(b) a VBE differential circuit coupled to the pre-regulator for generating a VBE differential voltage from the regulated voltage; and
(c) output circuitry coupled to the V_{BE} differential circuit for generating the reference voltage from the V_{BE} differential voltage and a base-emitter voltage drop.

7. The circuit of claim 6, wherein the current source comprises a Wilson current source.

8. The circuit of claim 6, wherein said first component comprises a V_{BE} multiplier.

9. The circuit of claim 6, wherein said second component comprises a proportional-to-absolute-temperature (PTAP) circuit.

10. The circuit of claim 6, wherein said VBE differential circuit is temperature compensated.

11. The circuit of claim 6, further comprising feedback circuitry coupled to the current source for regulating the current flow therefrom directly in response to feedback from the reference voltage, wherein the feedback circuitry comprises a feedback bipolar transistor.

12. The circuit of claim 6, wherein the output circuitry comprises an output bipolar transistor.

13. The circuit of claim 6, further comprising a start-up component coupled to the pre-regulator for drawing current from the current source at start-up.

14. The circuit of claim 13, wherein the start-up component includes a bipolar transistor biased by a resistor connected in series with a diode.

15. A method for providing a temperature compensated pre-regulated voltage for generating a reference voltage, the method comprising:
driving a current from a current source to a first component which generates a first voltage having a negative temperature coefficient;
driving the current to a second component coupled in series to said first component and to said current source, wherein said second component generates a second voltage having a positive temperature coefficient; and
combining the first and second voltage to provide the temperature compensated pre-regulated voltage.

16. The method of claim 15, wherein the act of driving a current into the first component includes driving the current with a Wilson current source.

17. The method of claim 15, wherein the act of generating a first voltage includes generating said voltage using a V_{BE} multiplier.

18. The method of claim 15, wherein the act of generating a second voltage includes generating said voltage using a proportional-to-absolute-temperature (PTAP) circuit.

19. The method of claim 15 further comprising regulating the current in response to feedback from the reference voltage, wherein the act of regulating includes regulating said current using feedback circuitry coupled to the current source.
